(19) United States
(12) Patent Application Publication
(10) Pub. No.: US 2026/0238943 A1
(43) Pub. Date: Aug. 13, 2026

(54) MICROPHONE TUNING METHOD

(71) Applicant: Harman Becker Gépkocsirendszer Gyártó Kft., Székesfehérvár (HU)

(72) Inventors: Viktor DOBOS, Székesfehérvár (HU); Balazs VARGA, Székesfehérvár (HU); Zoltán Giang-Son KLEINHEINCZ, Székesfehérvár (HU)

(73) Assignee: Harman Becker Gépkocsirendszer Gyártó Kft., Székesfehérvár (HU)

(21) Appl. No.: 19/538,574

(22) Filed: Feb. 12, 2026

(30) Foreign Application Priority Data
Feb. 13, 2025 (EP) 25 157 839.9

(51) Int. Cl. H04R 29/00; H04R 1/02; H04R 1/04; H04R 1/08; H04R 19/01

(52) U.S. Cl. CPC H04R 29/004; H04R 1/025; H04R 1/04; H04R 1/083; H04R 19/016; H04R 2201/003

(57) ABSTRACT

A method comprises determining a frequency response correction curve, wherein the frequency response correction curve corresponds to a difference between a first frequency response and a second frequency response, and applying the frequency response correction curve to a microphone output signal of a microphone element, thereby correcting a frequency response of the microphone element to a desired frequency response.

### CROSS-REFERENCE TO RELATED APPLICATIONS

This application claims priority to EP Application No 25 157 839.9 filed February 13, 2025, the disclosure of which is hereby incorporated in its entirety by reference herein.

### TECHNICAL FIELD

The disclosure relates to a microphone tuning method, in particular to a method for tuning invisible microphones covered by at least one material layer.

### BACKGROUND

Modern vehicles often incorporate systems that require sound input. For example, many vehicles include hands-free telephony capability. Hands-free telephony operates by using speakers and microphones within the vehicle instead of those associated with a cellular device. The cellular device may establish communication with the hands-free telephony system to transfer microphone and speaker data. Vehicles may further provide a voice recognition system for allowing the user to issue commands using spoken words.

Design effort is also expended to create a quiet cabin environment in vehicles. A typical goal in vehicle design is to minimize audible noise in the cabin. Consumers desire to be isolated from road noise, powertrain noise, and other unwanted noise sources. Some modern vehicles include a noise management system to reduce or change the character of the audible noise in a vehicle cabin. The noise management system may operate by generating noises or sounds that enhance the driving experience.

Such systems may operate by using microphones and speakers. The systems may receive audio signals from the microphones. As a variety of systems may utilize microphone inputs, vehicles may include one or more microphones located in various positions in a vehicle cabin. In this respect, it is a goal that any microphones arranged in a vehicle cabin be invisible for the occupants of the vehicle. Therefore, microphones are often covered by one or more layers of acoustically transparent material. Such layers, however, have an influence on the frequency response of the respective microphone.

There is a need for a method for tuning invisible microphones such that the respective microphones provide a desired frequency response.

### SUMMARY

A method according to embodiments of the disclosure is described herein. The method includes determining a frequency response correction curve, wherein the frequency response correction curve corresponds to a difference between a first frequency response and a second frequency response, and applying the frequency response correction curve to a microphone output signal of a microphone element, thereby correcting a frequency response of the microphone element to a desired frequency response.

Other systems, methods, features and advantages will be or will become apparent to one with skill in the art upon examination of the following detailed description and figures. It is intended that all such additional systems, methods, features and advantages be included within this description, be within the scope of the invention and be protected by the following claims.

### BRIEF DESCRIPTION OF THE DRAWINGS

The arrangement may be better understood with reference to the following description and drawings. The components in the figures are not necessarily to scale, emphasis instead being placed upon illustrating the principles of the invention. Moreover, in the figures, like referenced numerals designate corresponding parts throughout the different views.

FIG. 1 schematically illustrates a cross-sectional side-view of a microphone assembly.

FIG. 2 schematically illustrates frequency responses of a conventional microphone and an invisible microphone.

FIG. 3 schematically illustrates frequency responses of invisible microphones covered by different materials.

FIG. 4 schematically illustrates an example of a frequency response correction curve.

FIG. 5 schematically illustrates an assembly for determining a frequency response correction curve.

FIG. 6 schematically illustrates another assembly for determining a frequency response correction curve.

FIG. 7 schematically illustrates a method according to embodiments of the disclosure.

FIG. 8 schematically illustrates a method for determining a frequency response correction curve according to embodiments of the disclosure.

FIG. 9 schematically illustrates a method for determining a frequency response correction curve according to further embodiments of the disclosure.

### DETAILED DESCRIPTION

As required, detailed embodiments of the present invention are disclosed herein; however, it is to be understood that the disclosed embodiments are merely examples of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It is recognized that directional terms that may be noted herein (e.g., “upper”, “lower”, “inner”, “outer”, “top”, “bottom”, etc.) simply refer to the orientation of various components of an arrangement as illustrated in the accompanying figures. Such terms are provided for context and understanding of the disclosed embodiments.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, field-programmable gate arrays (FPGA), memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed herein.

Modern vehicles may include a variety of sound management systems and devices that cooperate to manage the aural environment within the vehicle. For example, a vehicle may include a road noise cancellation (RNC) system that is configured to reduce the amount of road noise heard by vehicle occupants. Such systems, typically operate by receiving input from one or more microphones and outputting a signal to one or more loudspeakers that modifies the sound pattern. The systems can mask unwanted road and engine noise making the cabin seem quieter. Other applications may include hands-free communication systems and telephone applications. Other vehicle sound management systems may include active noise control (ANC) and in-car communication (ICC) systems.

These vehicle systems use one or more microphones to receive sound/noise input. The microphones may be installed at various locations within the vehicle. Sound propagates through air as a sound pressure wave. A source may generate a sound by causing a vibration in the air (or other medium). These vibrations then propagate from the source through the medium (e.g., air). A microphone may operate by receiving these sound pressure waves and converting the sound pressure waves into an electrical signal. To accomplish this, the microphone element may need to be exposed to the sound pressure wave.

Existing in-vehicle microphones receive the sound pressure wave through openings that expose the cabin air to the microphone elements. As an example, a microphone may be installed in a headliner of the vehicle. In this respect, it is a goal that any microphones arranged in a vehicle cabin be invisible for the occupants of the vehicle. Therefore, microphones are often covered by one or more layers of acoustically transparent material. Such layers, however, have an influence on the frequency response of the respective microphone. Different car manufacturers generally use different headliner materials. Different headliner materials may also be used for different vehicle types of the same car manufacturer. That is, even if the same types of microphones are used, the layer(s) of acoustically transparent material may consist of different materials, have different thicknesses, etc. This has significant influence on the resulting frequency response of the respective microphone.

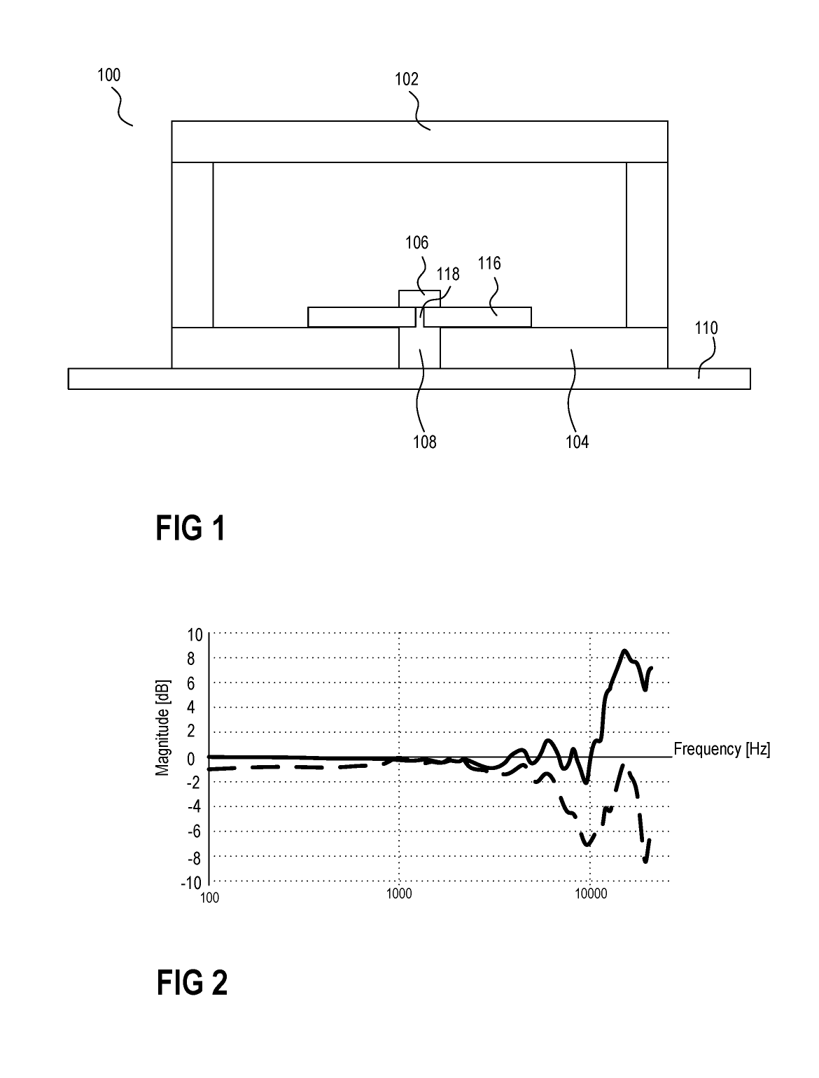

FIG. 1 schematically illustrates a cross-sectional side-view of a microphone assembly 100. The microphone assembly 100 includes a housing 102, a cover 104, and at least one microphone element 106 (hereafter “the microphone element 106”). The microphone assembly 100 is generally configured to be mounted in a vehicle. It is recognized that a portion of the vehicle that houses the microphone assembly 100 may define a cavity (not shown) that is suitable to receive the microphone assembly 100. The microphone element 106 arranged inside the housing 102 is generally configured to detect audio external to the housing 102 and to provide the detected audio to any controller (or processor, not shown) positioned in or about the vehicle. The detected audio may be provided to a controller wirelessly or via a wired connection, for example.

The housing 102 and the cover 104 can cooperate with one another to surround the microphone element 106. The cover 104 may be orientated to face the inside of a vehicle cabin. The housing 102 and the cover 104 may be separate components. For example, the cover 104 may be formed by an element of the vehicle. It is, however, also possible that the cover 104 and the housing 102 are integrally formed. That is, the cover 104 may be a part of the housing 102.

In one example, the microphone element 106 may be implemented as a Micro-Electro-Mechanical Systems, MEMS, microphone. The cover 104 may define a first opening 108 in order to enable the microphone element 106 to detect audio external to the housing 102. The first opening 108 enables the entry of acoustic sound without transforming the sound prior to receipt by the microphone element 106.

A printed circuit board, PCB, 116 may support the microphone element 106 and may include electrical traces and bonds in order to electrically couple with the microphone element 106. The PCB 116 may be arranged between the microphone element 106 and the first opening 108. The PCB 116 may define a second opening 118 that is aligned with the first opening 108 in order to enable sound that passes through the first opening 108 to be received by the microphone element 106.

At least one layer of acoustically transparent material 110 is arranged on an outside of the housing 102, with the cover 104 being arranged between the at least one layer of acoustically transparent material 110 and the PCB 116 with the microphone element 106 arranged thereon. The at least one layer of acoustically transparent material 110 may be configured to enable the audio to pass therethrough and into the first opening 108 for receipt by the microphone element 106. The microphone arrangement 100 is hidden behind the at least one layer of acoustically transparent material 110, such that the microphone arrangement 100 is invisible for occupants of the vehicle. The at least one layer of acoustically transparent material 110 may further be configured to serve as a barrier to prevent the entry of dust into an interior volume of the housing 102.

The housing 102 of the microphone assembly 100 may be formed in the vehicle. For example, the cover 104 may be formed by a headliner substrate of the vehicle. In this way, the microphone assembly 100 can be easily integrated into the vehicle in a space-saving manner while, at the same time, remaining visually unobtrusive. The microphone assembly 100 as described with respect to FIG. 1, however, is only one example. The microphone assembly 100 may be implemented in the vehicle in any other suitable way.

The microphone element 106 generally has a defined frequency response. The one or more layers of acoustically transparent material 110 arranged in front of the first opening 108, however, have an influence on the effective frequency response of the microphone element 106. This is schematically illustrated in FIG. 2. The continuous line as illustrated in FIG. 2 schematically illustrates the frequency response of a microphone element 106 as measured free-field, that is, without any interfering layers of acoustically transparent material arranged in front of the microphone element 106. The dashed line schematically illustrates a frequency response of the same microphone element 106 with one or more layers of acoustically transparent material 110 arranged in front of the microphone element 106, similar to what has been described with respect to FIG. 1 above. As can be seen, the frequency response as measured in free-field significantly differs from the frequency response of the same microphone element 106 with one or more layers of acoustically transparent material arranged in front of the microphone element 106, especially for higher frequencies.

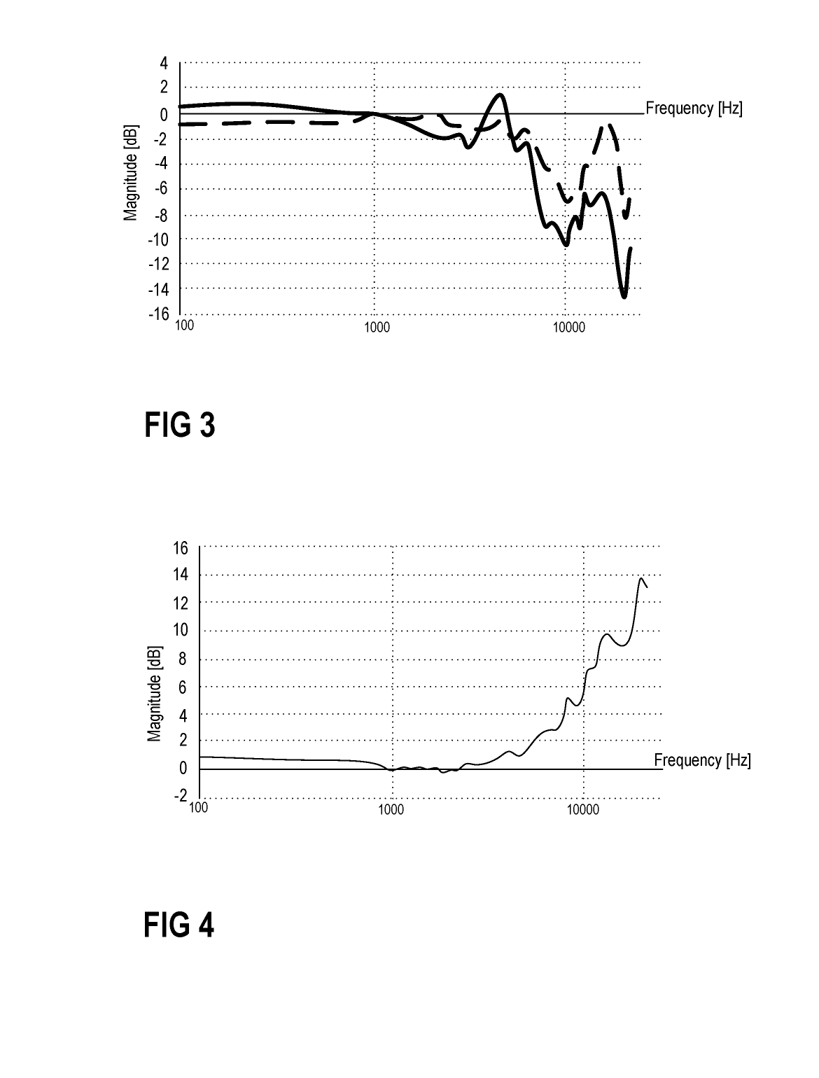

Different car manufacturers generally use different headliner materials. Different headliner materials may also be used for different vehicle types of the same car manufacturer. That is, even if the same types of microphones are used, the layer(s) of acoustically transparent material may consist of different materials, have different thicknesses, etc. This has significant influence on the resulting frequency response of the respective microphone element 106. This is schematically illustrated in FIG. 3. The continuous line as illustrated in FIG. 3 schematically illustrates the frequency response of a microphone element 106 with one or more layers of acoustically transparent material 110 of a first type (e.g., consisting of a first material) arranged in front of the microphone element 106. The dashed line schematically illustrates a frequency response of the same microphone element 106 with one or more layers of acoustically transparent material 110 of a second type (e.g., consisting of a second material that is different from the first material) arranged in front of the microphone element 106. Again the impact of the one or more layers of acoustically transparent material 110 is clearly visible, especially for higher frequencies.

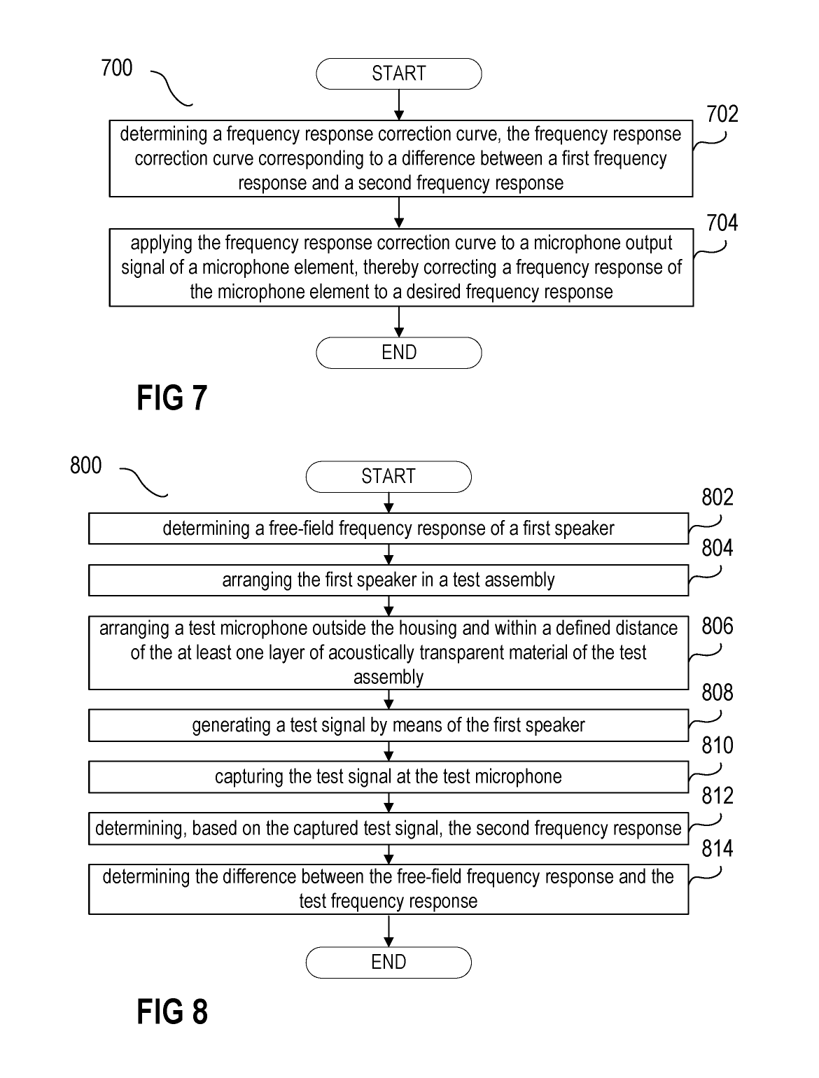

In order to eliminate the influence of the one or more layers of acoustically transparent material 100, a frequency response correction curve may be added to a microphone output signal. An example of a frequency response correction curve is schematically illustrated in FIG. 4. A method according to embodiments of the disclosure is schematically illustrated in the flow diagram of FIG. 7, the method comprises determining a frequency response correction curve, wherein the frequency response correction curve corresponds to a difference between a first frequency response and a second frequency response (step 702), and applying the frequency response correction curve to a microphone output signal of a microphone element 106, thereby correcting a frequency response of the microphone element 106 to a desired frequency response (step 704).

A frequency response correction curve can be determined in different ways. A method for determining a frequency response correction curve according to embodiments of the disclosure is schematically illustrated in FIG. 8. A corresponding arrangement that may be used for performing the method is schematically illustrated in FIG. 5. The method comprises determining the first frequency response, wherein the first frequency response is a free-field frequency response of a first speaker 130 (step 802). The method further comprises arranging the first speaker 130 in a test assembly (step 804). As is schematically illustrated in FIG. 5, the test assembly comprises a housing 102 configured to enclose a microphone and defining a first opening 108, a printed circuit board 116 arranged inside the housing 102, providing a surface for mounting a microphone, and defining a second opening 118 that is aligned with the first opening 108 such that the first opening 108 and the second opening 118 provide an air path between the outside and the inside of the housing 102, and at least one layer of acoustically transparent material 110 covering the first opening 108 on the outside of the housing 102 such that the air path provided by the first and second opening 108, 118 extends between the at least one layer of acoustically transparent material 110 and the surface for mounting a microphone. Arranging the first speaker 130 in the test assembly comprises arranging the first speaker 130 on the surface for mounting a microphone.

The method further comprises arranging a test microphone 132 outside the housing 102 and within a defined distance d1 of the at least one layer of acoustically transparent material 110 (step 806), wherein the at least one layer of acoustically transparent material 110 is arranged between the first speaker 130 and the test microphone 132, generating a test signal by means of the first speaker 130 (step 808), capturing the test signal at the test microphone 132 (810), determining, based on the captured test signal, the second frequency response, wherein the second frequency response is a test frequency response of the first speaker 130 arranged in the test assembly (812), and determining the difference between the first frequency response and the second frequency response (step 814), wherein the difference is representative of an influence of the at least one layer of acoustically transparent material 110 on the frequency response of the first speaker 130.

In some embodiments, the test assembly is a microphone assembly 100 mounted to a vehicle. In such cases, the method may further comprise, after determining the second frequency response, removing the first speaker 130 from the test assembly, arranging a microphone element 106 in the test assembly, wherein arranging the microphone element 106 in the test assembly comprises arranging the microphone element 106 on the surface for mounting a microphone, and applying the frequency response correction curve to a microphone output signal of the microphone element 106. The method may further comprise removing the test microphone 132.

That is, each and every microphone arrangement 100 may be tested separately. In this way, a high accuracy of the frequency response correction curve can be ensured. However, testing every microphone arrangement separately may be cumbersome and costly. Therefore, this method may not be an option for some vehicles, e.g., low and medium priced vehicles.

According to alternative embodiments, the frequency response correction curve may be determined by means of a separate test arrangement which is identical to microphone assemblies 100 that are mounted to one or more vehicles. The components, dimensions and materials of the test assembly are identical to those of the actual microphone assemblies 100. In such cases, the method may further comprise arranging a microphone element 106 in a microphone assembly 100, the microphone assembly 100 being identical to the test assembly, wherein arranging the microphone element 106 in the microphone assembly 100 comprises arranging the microphone element (106) on the surface for mounting a microphone, and applying the frequency response correction curve to a microphone output signal of the microphone element 106.

In all of the embodiments described above, arranging the test microphone 132 within a defined distance d1 of the first opening 108 may comprise, for example, arranging the test microphone 132 at a defined distance d1 of between 0.1mm and 10cm, or between 0.1mm and 5cm from the at least one layer of acoustically transparent material 110. That is, the test microphone 132 may be arranged as close as possible to the layer of acoustically transparent material 110 and, therefore, to the first opening 108. Arranging a test microphone 132 within a defined distance d1 of the at least one layer of acoustically transparent material 110 may additionally or alternatively comprise aligning the test microphone 132 with the first opening 108.

The first speaker 130 may be a Micro-Electro-Mechanical Systems, MEMS, speaker, for example. That is, arranging the first speaker 130 in a test assembly may comprise arranging a Micro-Electro-Mechanical Systems, MEMS, speaker in the test assembly.

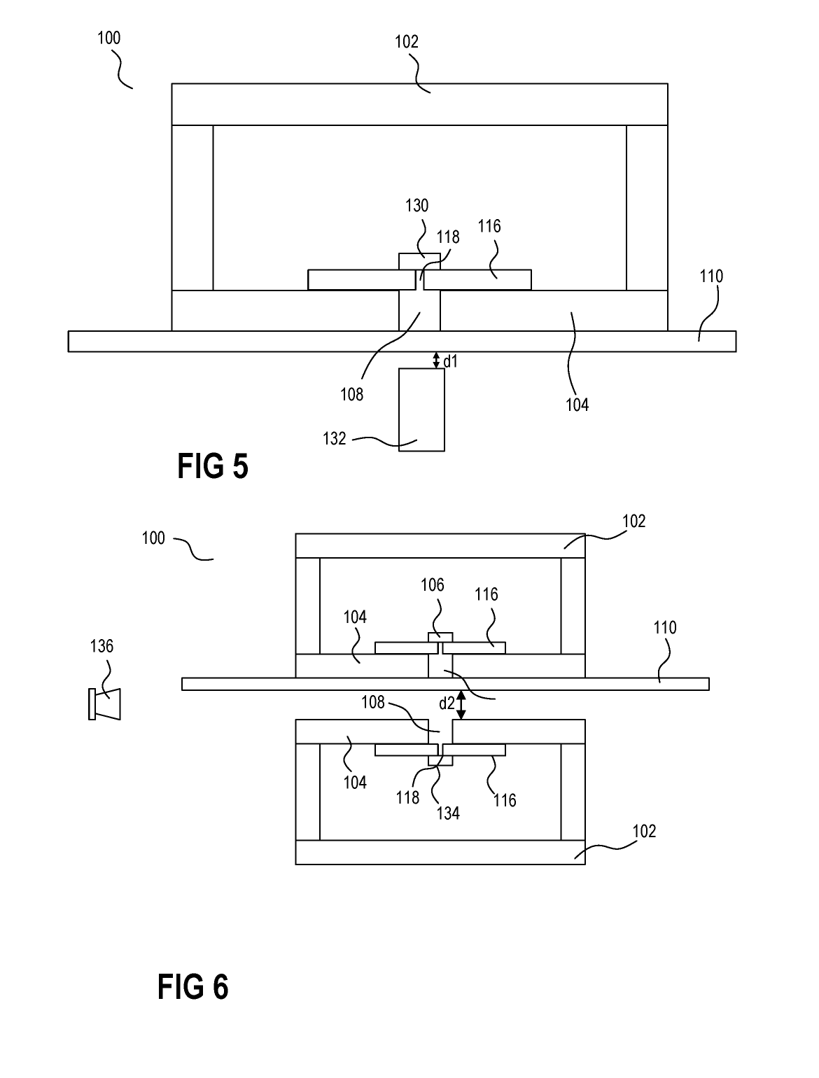

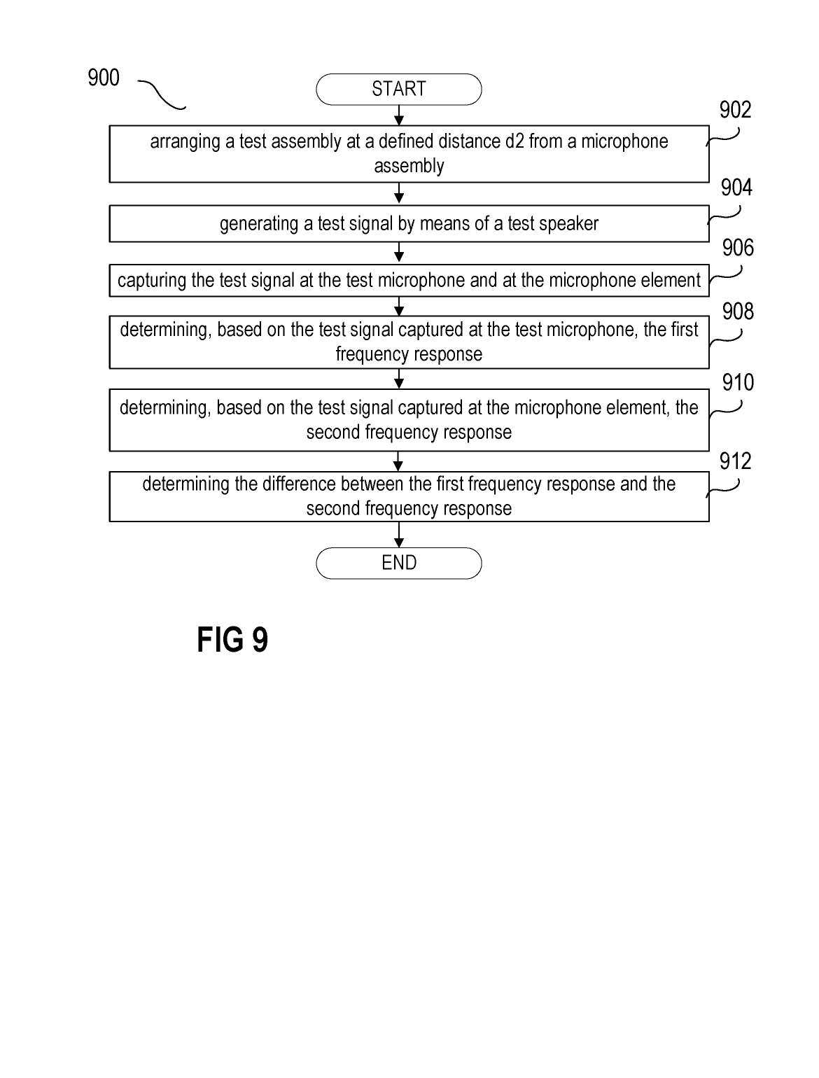

Now referring to FIGS. 6 and 9, according to alternative embodiments, determining the frequency response correction curve may comprise arranging a test assembly at a defined distance d2 from a microphone assembly 100 (step 902). As is schematically illustrated in FIG. 6, the test assembly comprises a housing 102 defining a first opening 108, a printed circuit board 116 arranged inside the housing 102, providing a surface for mounting a microphone, and defining a second opening 118 that is aligned with the first opening 108 such that the first opening 108 and the second opening 118 provide an air path between the outside and the inside of the housing 102, and a test microphone 134, wherein the test microphone 134 is arranged on the surface for mounting a microphone. The microphone assembly 100 comprises a housing 102 defining a first opening 108, a printed circuit board 116 arranged inside the housing 102, providing a surface for mounting a microphone, and defining a second opening 118 that is aligned with the first opening 108 such that the first opening 108 and the second opening 118 provide an air path between the outside and the inside of the housing 102, at least one layer of acoustically transparent material 110 covering the first opening 108 on the outside of the housing 102 such that the air path provided by the first and second opening 108, 118 extends between the at least one layer of acoustically transparent material 110 and the surface for mounting a microphone, and a microphone element 106, wherein the microphone element 106 is arranged on the surface for mounting a microphone. The method further comprises generating a test signal by means of a test speaker 136 (step 904), capturing the test signal at the test microphone 134 and at the microphone element 106 (step 906), determining, based on the test signal captured at the test microphone 134, the first frequency response (step 908), wherein the first frequency response corresponds to a frequency response of the test microphone 134 arranged in the test assembly, determining, based on the test signal captured at the microphone element 106, the second frequency response (step 910), wherein the second frequency response corresponds to a frequency response of the microphone element 106 arranged in the microphone assembly 100, and determining the difference between the first frequency response and the second frequency response (step 912), wherein the difference is representative of an influence of the at least one layer of acoustically transparent material 110.

The test assembly and the microphone assembly may be (almost) identical to each other (e.g., materials, dimensions, components), the only difference being that the first opening of the microphone assembly is covered by at least one layer of acoustically transparent material 110. As the first opening 108 of the test assembly is arranged at a defined distance d2 from the first opening 108 of the test assembly, both assemblies receive essentially the same test signal as generated by the test speaker 126 at the same time. Any differences between the first frequency response and the second frequency response, therefore, essentially only depend on the at least one layer of acoustically transparent material 110 arranged in front of the first opening 108 of the microphone assembly 100. The first frequency response corresponds to a frequency response of the test microphone 134 arranged in the test assembly, and further essentially equals a free-field frequency response of the microphone element 106 of the microphone assembly 100.

Arranging the test assembly at a defined distance d2 from a microphone assembly 100 may, for example, comprise arranging the test assembly at a defined distance d2 of between 0.1mm and 10cm, or between 0.1mm and 5cm from the microphone assembly 100. That is the microphone assembly and the test assembly may be arranged as close to each other as possible. In this way, it can be ensured that both assemblies receive essentially the same test signal at the same time. A certain distance d2 between the test assembly and the microphone assembly is generally required such that the test signal can reach the first opening 108 of the test assembly as well as the first opening 108 of the microphone assembly. A certain distance between the first opening 108 of the test assembly and the at least one layer of acoustically transparent material 110 of the microphone assembly 100 should also remain in order to ensure that the first opening 108 of the test assembly is not covered in any way.

According to some embodiments, arranging the test assembly at a defined distance d2 from the microphone assembly 100 may comprise aligning the first opening 108 defined by the housing 102 of the test assembly with the first opening 108 defined by the housing 102 of the microphone assembly 100, similar to what is schematically illustrated in FIG. 6. In this way, a distance between the test speaker 136 and the first opening 108 of the test assembly is essentially the same as a distance between the test speaker 136 and the first opening of the microphone assembly 100. In this way, it can be ensured that a difference between the first frequency response and the second frequency response essentially only depends on the at least one layer of acoustically transparent material 110 arranged in front of the first opening 108 of the microphone assembly.

As has been described above, a frequency response correction curve that can be used to correct a frequency response of a microphone element 106 of a microphone assembly to a desired frequency response can be determined in different ways. For example, the microphone element 106 of a microphone assembly 100 may be replaced by a first speaker as part of the process of determining the frequency response correction curve. Once the frequency response correction curve has been determined, the first speaker 130 may be removed and the microphone element 106 may be arranged in the microphone assembly 100. The frequency response correction curve, however, may also be used to correct a frequency response of a microphone element 106 of a different microphone assembly to a desired frequency response, wherein the microphone assembly and the microphone element 106 are identical to the microphone assembly and the microphone element 106 that were used to determine the frequency response correction curve.

Alternatively, the microphone element 106 may remain in the microphone assembly 100, and an additional test assembly may be used to determine the frequency response correction curve. In this case, the microphone assembly and the test assembly are identical to each other, the only difference being that the first opening 108 of the microphone assembly 100 is covered by at least one layer of acoustically transparent material 110, and the first opening 108 of the test assembly is not covered at all.

In the latter case, the microphone assembly 110 may be a microphone assembly 100 arranged in a vehicle. The test speaker 136 may be any speaker of the vehicle, for example. It is, however, also possible that an external speaker be used to output the test signal.

In all different cases, the step of determining the frequency response correction curve may be performed once at the end of the development phase of a vehicle for example. That is, the measurements may be performed for a single vehicle only. It may generally be assumed that the same frequency response correction curve can also be applied to other, identical, microphone assemblies 100. However, there may be slight differences between the frequency response correction curve of different microphone assemblies 100, e.g., due to production tolerances. Such differences may be acceptable in most cases. In order to provide an accurate frequency response correction curve for each and every microphone assembly 100, each microphone assembly 100 may be tested separately. In this way, a unique correction curve can be determined for every microphone assembly 100 of every single vehicle. However, this significantly increases the costs of a vehicle, as additional time is required to perform the individual testing. Therefore, this may only be done in some cases, e.g., for luxury and high class vehicles.

If a test assembly is used to determine the frequency response correction curve, the test assembly may be or may be part of a separate testing device which is removed after the test has been performed. It is, however, also possible that the test assembly be mounted in the vehicle, after the test has been performed. For example, the microphone assembly may be arranged in a headliner of the vehicle on a driver’s side. The test may be performed in order to determine the frequency response correction curve as has been described above. Subsequently, the test assembly may be mounted, e.g., in the headliner of the vehicle on the front passenger’s side, or at any other suitable position in the vehicle. Most vehicles today comprise at least two microphone assemblies. As the test assembly is identical to the microphone assembly, and the headliner material is generally the same at any position of the vehicle, the same frequency response correction curve may subsequently also be used for the test assembly once it is mounted to the vehicle.

The description of embodiments has been presented for purposes of illustration and description. Suitable modifications and variations to the embodiments may be performed in light of the above description or may be acquired from practicing the methods. The described arrangements are exemplary in nature, and may include additional elements and/or omit elements. As used in this application, an element recited in the singular and proceeded with the word “a” or “an” should not be understood as excluding the plural of said elements, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The described systems are exemplary in nature, and may include additional elements and/or omit elements. The subject matter of the present disclosure includes all novel and non-obvious combinations and sub-combinations of the various systems and configurations, and other features, functions, and/or properties disclosed. The following claims particularly disclose subject matter from the above description that is regarded to be novel and non-obvious.

What is claimed is:

1. A method comprising:
determining a frequency response correction curve, wherein the frequency response correction curve corresponds to a difference between a first frequency response and a second frequency response; and
applying the frequency response correction curve to a microphone output signal of a microphone element, thereby correcting a frequency response of the microphone element to a desired frequency response.

2. The method of claim 1, wherein determining the frequency response correction curve comprises:
determining the first frequency response, wherein the first frequency response is a free-field frequency response of a first speaker;
arranging the first speaker in a test assembly, the test assembly comprising
a housing configured to enclose a microphone and defining a first opening,
a printed circuit board arranged inside the housing, providing a surface for mounting a microphone, and defining a second opening that is aligned with the first opening such that the first opening and the second opening provide an air path between the outside and the inside of the housing, and
at least one layer of acoustically transparent material covering the first opening on the outside of the housing such that the air path provided by the first and second opening extends between the at least one layer of acoustically transparent material and the surface for mounting a microphone;
wherein arranging the first speaker in the test assembly comprises arranging the first speaker on the surface for mounting a microphone;
arranging a test microphone outside the housing and within a defined distance (d1) of the at least one layer of acoustically transparent material, wherein the at least one layer of acoustically transparent material is arranged between the first speaker and the test microphone;
generating a test signal by means of the first speaker;
capturing the test signal at the test microphone;
determining, based on the captured test signal, the second frequency response, wherein the second frequency response is a test frequency response of the first speaker arranged in the test assembly; and
determining the difference between the first frequency response and the second frequency response, wherein the difference is representative of an influence of the at least one layer of acoustically transparent material on the frequency response of the first speaker.

3. The method of claim 2, further comprising
after determining the second frequency response, removing the first speaker from the test assembly;
arranging a microphone element in the test assembly, wherein arranging the microphone element in the test assembly comprises arranging the microphone element on the surface for mounting a microphone; and
applying the frequency response correction curve to a microphone output signal of the microphone element.

4. The method of claim 3, further comprising removing the test microphone.

5. The method of claim 2, further comprising
arranging a microphone element in a microphone assembly, the microphone assembly being identical to the test assembly, wherein arranging the microphone element in the microphone assembly comprises arranging the microphone element on the surface for mounting a microphone; and
applying the frequency response correction curve to a microphone output signal of the microphone element.

6. The method of claim 2, wherein arranging a test microphone within a defined distance (d1) of the at least one layer of acoustically transparent material comprises arranging the test microphone at a defined distance (d1) of between 0.1mm and 10cm, or between 0.1mm and 5cm from the at least one layer of acoustically transparent material.

7. The method of claim 2, wherein arranging a test microphone within a defined distance (d1) of the at least one layer of acoustically transparent material comprises aligning the test microphone with the first opening.

8. The method of claim 2, wherein arranging the first speaker in a test assembly comprises arranging a Micro-Electro-Mechanical Systems, MEMS, speaker in the test assembly.

9. The method of claim 1, wherein determining the frequency response correction curve comprises:
arranging a test assembly at a defined distance (d2) from a microphone assembly, the test assembly comprising
a housing defining a first opening,
a printed circuit board arranged inside the housing,
providing a surface for mounting a microphone, and defining a second opening that is aligned with the first opening such that the first opening and the second opening provide an air path between the outside and the inside of the housing, and a test microphone,
wherein the test microphone is arranged on the surface for mounting a microphone, and the microphone assembly comprising a housing defining a first opening, a printed circuit board arranged inside the housing,
providing a surface for mounting a microphone, and defining a second opening that is aligned with the first opening such that the first opening and the second opening provide an air path between the outside and the inside of the housing, at least one layer of acoustically transparent material covering the first opening on the outside of the housing such that the air path provided by the first and second opening extends between the at least one layer of acoustically transparent material and the surface for mounting a microphone, and a microphone element, wherein the microphone element is arranged on the surface for mounting a microphone;
generating a test signal by means of a test speaker;
capturing the test signal at the test microphone and at the microphone element;
determining, based on the test signal captured at the test microphone, the first frequency response, wherein the first frequency response corresponds to a frequency response of the test microphone arranged in the test assembly;
determining, based on the test signal captured at the microphone element, the second frequency response, wherein the second frequency response corresponds to a frequency response of the microphone element arranged in the microphone assembly; and
determining the difference between the first frequency response and the second frequency response, wherein the difference is representative of an influence of the at least one layer of acoustically transparent material.

10. The method of claim 9, wherein arranging a test assembly at a defined distance (d2) from a microphone assembly comprises arranging the test assembly at a defined distance (d2) of between 0.1mm and 10cm, or between 0.1mm and 5cm from the microphone assembly.

11. The method of claim 9, wherein arranging a test assembly at a defined distance (d2) from a microphone assembly comprises aligning the first opening defined by the housing of the test assembly with the first opening defined by the housing of the microphone assembly.

12. A method comprising:
determining a frequency response correction curve, wherein the frequency response correction curve corresponds to a difference between a first frequency response and a second frequency response; and
applying the frequency response correction curve to a microphone output signal of a microphone element, thereby correcting a frequency response of the microphone element to a desired frequency response,
wherein determining the frequency response correction curve comprises:
determining the first frequency response, wherein the first frequency response is a free-field frequency response of a first speaker;
arranging the first speaker in a test assembly.

13. The method of claim 12, wherein the test assembly includes
a housing configured to enclose a microphone and defining a first opening,
a printed circuit board arranged inside the housing, providing a surface for mounting a microphone, and defining a second opening that is aligned with the first opening such that the first opening and the second opening provide an air path between the outside and the inside of the housing, and
at least one layer of acoustically transparent material covering the first opening on the outside of the housing such that the air path provided by the first and second opening extends between the at least one layer of acoustically transparent material and the surface for mounting a microphone.

14. The method of claim 13,
wherein arranging the first speaker in the test assembly includes:
arranging the first speaker on the surface for mounting a microphone;
arranging a test microphone outside the housing and within a defined distance (d1) of the at least one layer of acoustically transparent material, wherein the at least one layer of acoustically transparent material is arranged between the first speaker and the test microphone;
generating a test signal by means of the first speaker;
capturing the test signal at the test microphone;
determining, based on the captured test signal, the second frequency response, wherein the second frequency response is a test frequency response of the first speaker arranged in the test assembly; and
determining the difference between the first frequency response and the second frequency response, wherein the difference is representative of an influence of the at least one layer of acoustically transparent material on the frequency response of the first speaker.

15. The method of claim 14, further comprising
after determining the second frequency response, removing the first speaker from the test assembly;
arranging a microphone element in the test assembly, wherein arranging the microphone element in the test assembly comprises arranging the microphone element on the surface for mounting a microphone; and
applying the frequency response correction curve to a microphone output signal of the microphone element.

16. The method of claim 3, further comprising removing the test microphone.

17. A test assembly, comprising:
a housing configured to enclose a microphone and defining a first opening,
a printed circuit board arranged inside the housing, providing a surface for mounting a microphone, and defining a second opening that is aligned with the first opening such that the first opening and the second opening provide an air path between the outside and the inside of the housing, and
at least one layer of acoustically transparent material covering the first opening on the outside of the housing such that the air path provided by the first and second opening extends between the at least one layer of acoustically transparent material and the surface for mounting a microphone.

18. The test assembly of claim 17, further comprising a test microphone arranged, within a defined distance (d1) of the at least one layer of acoustically transparent material comprises arranging the test microphone at a defined distance (d1) of between 0.1mm and 10cm, or between 0.1mm and 5cm from the at least one layer of acoustically transparent material.

19. The test assembly of claim 17, further comprising a test microphone arranged within a defined distance (d1) of the at least one layer of acoustically transparent material comprises aligning the test microphone with the first opening.

20. The test assembly of claim 17, further comprising a Micro-Electro-Mechanical Systems, MEMS, speaker.
